(19) United States
(12) Patent Application Publication
(10) Pub. No.: US 2026/0329337 A1
(43) Pub. Date: Oct. 22, 2026

(54) WEARABLE ELECTRONIC DEVICE

(71) Applicant: Apple Inc., Cupertino, CA (US)

(72) Inventors: Matin Seadat Beheshti, Sunnyvale, CA (US); Christian I Moore, Sunnyvale, CA (US); Daniel G Lussier, Alta, CA (US); Sean A Mayo, Sunnyvale, CA (US)

(21) Appl. No.: 19/355,673

(22) Filed: Oct. 10, 2025

Related U.S. Application Data
(60) Provisional application No. 63/792,443, filed on Apr. 22, 2025.

(51) Int. Cl. G06F 1/16

(52) U.S. Cl. CPC G06F 1/163

(57) ABSTRACT

A head-mountable display device can include a first display assembly including a first display and a first housing surrounding the first display, a second display assembly including a second display and a second housing surrounding the second display, a first securement arm extending from the first housing, and a second securement arm extending from the second housing. The head-mountable display device further includes a data transmission cable electrically coupled to the first display and extending through the first securement arm, an electrical port coupled to the first display and the second display via the data transmission cable, the data transmission cable extending uninterrupted between the electrical port and the first display, and the electrical port is configured to connect to an external computing unit configured to control visual output of the first display and the second display.

### CROSS-REFERENCE TO RELATED APPLICATIONS

This application claims the benefit of U.S. Provisional Application No. 63/792,443, filed 22 Apr. 2025, entitled “WEARABLE ELECTRONIC DEVICE,” the entire disclosure of which is hereby incorporated by reference.

### TECHNICAL FIELD

The present disclosure relates generally to electronic devices. More particularly, the present disclosure relates to head-mountable electronic devices.

### BACKGROUND

Various components of head-mountable devices (HMD), such as display screens, viewing frames, securement arms, speakers, batteries, waveguide, and other components, can operate together to provide immersive alternate, mixed, and virtual reality experiences. These components are conventionally housed within the HMD. These components can add significant weight to the HMD. This weight can lead to discomfort over long durations of use. In some traditional configurations, the weight can be distributed by a securement band via padding on the HMD for the user's nose, by securement arms distributing weight to the user's ears, or the like. HMDs can be used in a variety of different settings and during a variety of different activities. These can range from working in an office, to mountain biking or hiking outdoors. However, the weight of the HMD can be uncomfortable to a user during extended use. Therefore, there is a need for an HMD with reduced weight to increase the user's comfortability during extended use of the HMD.

### SUMMARY

In at least one example of the present disclosure, a head-mountable display device (HMD) can include a first display assembly that can include a first display and a first housing surrounding the first display, a second display assembly that can include a second display and a second housing surrounding the second display, a first securement arm extending from the first housing, and a second securement arm extending from the second housing. The HMD can further include a data transmission cable electrically coupled to the first display and extending through the first securement arm, an electrical port coupled to the first display and the second display via the data transmission cable, the data transmission cable extending uninterrupted between the electrical port and the first display, and the electrical port can connect to an external computing unit that can control visual output of the first display and the second display.

In at least one example, the HMD is free of computing components. In at least one example, the external computing unit includes a processor and can send all control signals received by the first display and the second display via the data transmission cable. In at least one example, the first display assembly and the second display assembly are passively cooled. In at least one example, the first housing defines a first internal volume, and the second housing defines a second internal volume isolated form the first internal volume by the first housing and the second housing. The HMD further include a bridge extending between and connecting the first housing and the second housing and the data transmission cable extends through the bridge. In at least one example, the HMD further includes a power cable extending through the second securement arm and electrically coupled to the second display and the first display.

In another example of the present disclosure, a wearable display device can include a first display module can include a first lens, a first housing surrounding the first lens and defining a first internal volume, and a first display screen disposed in the first internal volume and can project light through the first lens. The wearable display device can further include a second display module that can include a second lens, a second housing surrounding the second lens and defining a second internal volume isolated from the first internal volume by the first housing and the second housing, and a second display screen disposed in the second internal volume and can project light through the second lens. The wearable display device can further include a first temple arm extending from the first display module, and a second temple arm extending from the second display module.

In at least one example, the wearable display device can further include a first cap coupled to the first housing opposite the first display screen, the first housing disposed between the first lens and the first cap, and a second cap separate from the first cap and coupled to the second housing opposite the second display screen, the second housing disposed between the second lens and the second cap. In one example, the wearable display device can further include a data transmission cable electrically coupled to the first display screen and extending through the first temple arm. In one example, the wearable display device further including an electrical port electrically coupled to the first display screen and the second display screen via the data transmission cable, the data transmission cable extending between the electrical port and the first display screen without being electrically coupled to any intervening processing component between the electrical port and the display screen. In at least one example, the first display module nor the second display module includes a cooling fan. In at least one example, the first housing and the second housing can include vent holes. In at least one example, the wearable display device can further include a bridge extending between the first housing and the second housing to separate and couple the first housing and the second housing.

In yet another example of the present disclosure, a HMD can include a first display assembly that can include a first display, a first housing surrounding the first display and defining an first external surface, a first lens coupled to the first housing, and a first cap coupled to the first housing opposite the first lens, the first display disposed between the first lens and the first cap. The HMD can further include a second display assembly that can include a second display, a second housing surrounding the second display and defining a second external surface separate and isolated from the first external surface, a second lens coupled to the second housing, and a second cap coupled to the second housing opposite the second lens, the second display disposed between the second lens and the second cap. The first display can block light from passing between the first lens and the first cap, and the second display can block light from passing between the second lens and the second cap.

In at least one example, the first cap and the second cap are opaque. In at least one example, the HMD can further include a bridge extending between and connecting the first housing and the second housing, and a first securement arm extending from the first housing and a second securement arm extending from the second housing. In at least one example, the HMD can further include a data transmission cable extending through the first securement arm and electrically coupled to the first display and the second display, and a power cable extending through the second securement arm and electrically coupled to the first display and the second display.

### BRIEF DESCRIPTION OF THE SEVERAL VIEWS OF THE DRAWINGS

The disclosure will be readily understood by the following detailed description in conjunction with the accompanying drawings, wherein like reference numerals designate like structural elements, and in which:

FIG. 1 illustrates an isometric view of an example of a head-mountable device (HMD);

FIG. 2A illustrates a top view of an example of an HMD;

FIG. 2B illustrates a front view of an example of an HMD;

FIG. 3A illustrates front isometric portion of an example of an HMD;

FIG. 3B illustrates a rear isometric portion of an example of an HMD;

FIG. 4A. Illustrates an exploded view of an example of an HMD;

FIG. 4B illustrates a cross-section view of an example of an HMD through cut line A-A of FIG. 2B; and

FIG. 5 illustrates a side view of an example of an HMD.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to head-mountable devices (HMD). HMDs can be donned on the user's head to provide an immersion experience in virtual reality (VR), augmented reality (AR), and mixed reality (MR). The HMD can be used in a variety of different settings and during a variety of different activities. These can range from working in an office, to mountain biking or hiking outdoors. For example, the user can don the HMD in a non-office environment and complete work through the use of the HMD if the user does not have access to a computer or computer monitors. In this example, the HMD can display a plurality of computer monitors to the user just as if the user were in the office environment. In another example, the user can don the HMD to view a sporting event as if they were seated on the floor of the sporting arena while they are in the comfort of their own home. However, current HMDs include various components, such as display screens, viewing frames, securement arms, speakers, batteries, waveguide, and other components, which are conventionally housed within the HMD. These components can add significant weight to the HMD that is donned on the user's head. This can lead to a user becoming fatigued after an extended period of time. Therefore, a user could not wear the HMD all day or during a typical eight-hour work shift without becoming fatigued and uncomfortable. The multitude of components also requires energy storage capability from batteries that can add to the weight of the device.

The following disclosure relates to an HMD that has reduced weight so it can be worn by a user during an eight-hour work shift or all day. In at least one example, the HMD can be free of computing components and cooling components, thus limiting the needed on-board battery capacity, and reducing the overall weight of the device. Without the additional weight of the computing components and the cooling components needed for the computing components, the weight of the HMD is significantly reduced. Therefore, the HMD can be donned by the user for longer durations of time.

In at least one example, an HMD can include a first display module that can include a first lens, a first housing surrounding the first lens and defining a first internal volume, and a first display screen disposed in the first internal volume that can project light through the first lens. The HMD can further include a second display module that can include a second lens, a second housing surrounding the second lens and defining a second internal volume isolated from the first internal volume by the first housing and the second housing, and a second display screen disposed in the second internal volume that can project light through the second lens. In this way, the HMD can include two independent housings with independent lenses, and display screens.

In at least one example, the HMD can include a first securement arm extending from the first housing and a second securement arm extending from the second housing. The HMD can include a data transmission cable electrically coupled to the first display and extending through the first securement arm, and an electrical port electrically coupled to the first display and the second display via the data transmission cable. The electrical port can connect to an external computing unit can control visual outputs of the first display and the second display. In at least one example, the HMD can further include a power cable extending through the second securement arm and electrically couple to the second display and the first display. In at least one example, the external computing unit can include a processor, a battery, cooling fans, and/or the like. In this way, the HMD does not include cooling fans or the computing unit. This can significantly reduce the weight of the HMD to increase the comfort of the HMD during long durations of use without sacrificing any performance.

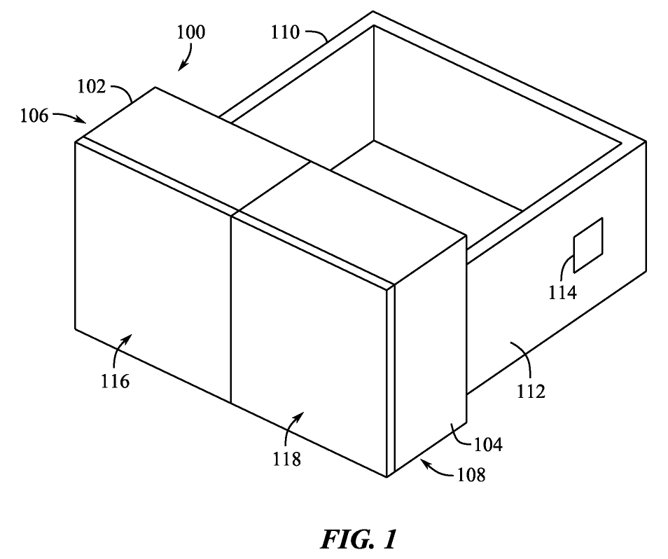

These and other embodiments are discussed below with reference to FIGS. 1 – 5. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an isometric view of a head-mountable device 100 (HMD 100). The HMD 100 can be any device or system that can be worn on the head of the user, such as a head-mountable electronic device, an optical device, smart glasses, mixed reality goggles, and the like. As shown in FIG. 1, the HMD 100 can include a first display assembly 102 and a second display assembly 104. In at least one example, the first display assembly 102 and the second display assembly 104 can be secured in front of the user's eyes when the HMD 100 is donned. For example, the first display assembly 102 in front of the right eye, the second display assembly 104 in front of the left eye, or vice versa. The first display assembly 102 can include a first display (not illustrated) and a first housing 106 surrounding the first display. In this way, the first display is positioned in front of the user's eye. The second display assembly 104 can include a second display and a second housing 108 surrounding the second display, wherein the second display is positioned in front of the user's eye. In this way, the HMD 100 defines two individual housings with independent display assemblies.

In at least one example, the HMD 100 can include a first securement arm 110 extending from the first housing 106 and a second securement arm 112 extending from the second housing 108. In at least one example, the first securement arm 110 and the second securement arm 112 can rest on the user's ear to distribute the weight of the HMD 100. In at least one example, the first securement arm 110 and the second securement arm 112 can further include curvature on a distal end of the first securement arm 110 and the second securement arm 112 to secure behind the ears of the user to increase the stability of the HMD 100 during all activity types. In at least one example, the HMD 100 can include a strap, a band, or the like rather than securement arms.

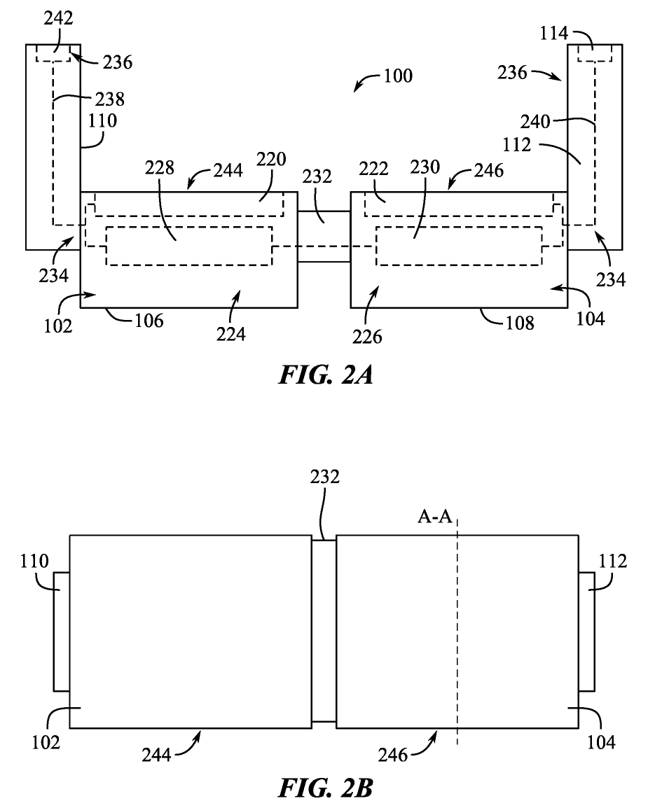

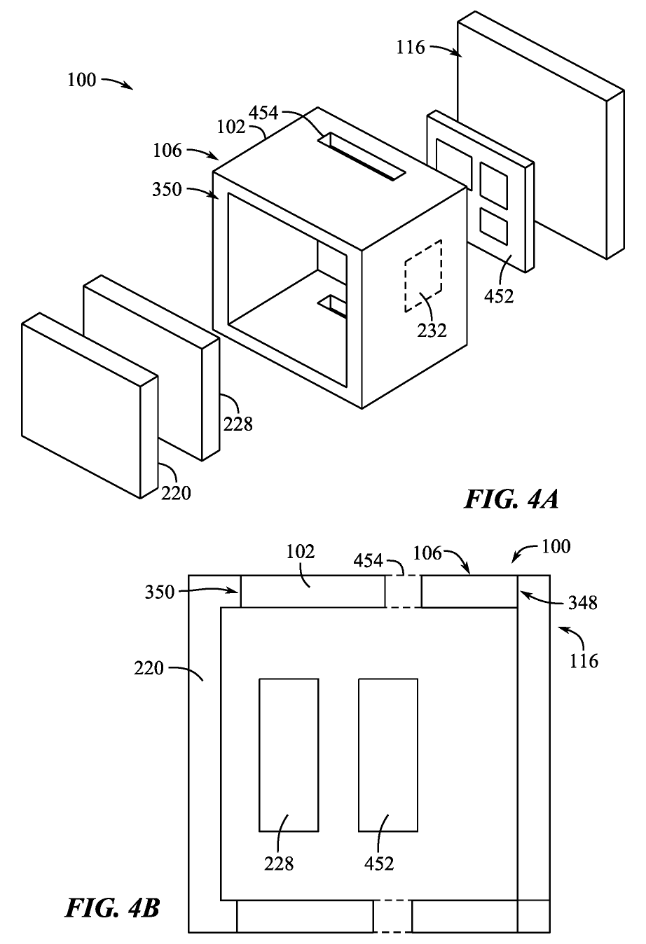

In at least one example, the HMD 100 can include a data transmission cable electrically coupled to the first display and extending through the first securement arm 110 (as illustrated in FIG. 2A). In at least one example, the HMD 100 can further include an electrical port 114 that can be electrically coupled to the first display and the second display via the data transmission cable. The electrical port can connect to an external computing unit that can control visual outputs of the first display and the second display. Although the electrical port 114 is illustrated on the second securement arm 112 in FIG. 1, it should be understood it can be on the first securement arm 110 or both the first securement arm 110 and the second securement arm 112. Furthermore, it should be understood the electrical port 114 can be located on any position along the first securement arm 110 and the second securement arm 112 and can be on the distal end of the first securement arm 110 and the second securement arm 112. The external computing unit can include a processor that can send all control signals received by the first display and the second display via the data transmission cable. In at least one example, the external computing unit can further include memory, storage, power supply, and the like. In this way, the HMD 100 does not house computing components and neither the first display assembly 102 nor the second display assembly 104 include a cooling fan. As discussed in more detail below with respect to FIGS. 4A and 4B, the first display assembly 102 and the second display assembly 104 can include cooling vents in order to cool the electronic components housed within the first display assembly 102 and the second display assembly 104. With the HMD 100 free of computing components the HMDs 100 weight can be significantly reduced to increase the comfort and allow the user to don the HMD 100 for longer times.

As illustrated in FIG. 1, the HMD 100 can further include a first cap 116 coupled to the first housing 106 opposite the first display screen, and a second cap 118 separate from the first cap 116 coupled to the second housing 108 opposite the second display screen. In at least one example, the first cap 116 and the second cap 118 can be opaque. In this way, the HMD 100 can be used for VR because the user cannot see through first display assembly 102 and the second display assembly 104. Furthermore, the first cap 116 and the second cap 118 stop light from the first display and the second display from leaking out the front of the first display assembly 102 and the second display assembly 104. In at least one example, the HMD 100 can further include eyecups or blinders (not illustrated) that can secure to the first housing 106 and the second housing 108. In this example, the eye cups can secure onto the eye socket of the user to enable full emersion with the HMD 100. This can further reduce the light leakage from the display to the user's eyes that can increase the immersion. Furthermore, the eye cups can enable loading onto the eye sockets that will further distribute the weight of the HMD 100 for a more comfortable use. In at least one example, the HMD 100 can include the blinders coupled to the first securement arm 110 and the second securement arm 112 that can block light from the user's environment while the user dons the HMD 100.

Any of the features, components, and/or parts, of the electronic device including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

FIGS. 2A-2B illustrate various views of the HMD 100. FIG. 2A illustrates a top view of the HMD 100 of FIG. 1. FIG. 2B illustrates a front view of the HMD 100 of FIG. 1. The HMD 100 can include a first display assembly 102 and a second display assembly 104. The first display assembly 102 can include a first lens 220, a first housing 106 surrounding the first lens 220 and defining a first internal volume 224, and a first display screen 228 disposed in the first internal volume 224 that can project light through the first lens 220. As illustrated in FIG. 2A, the first lens 220 can be positioned in front of the user's eye such that as the first display screen 228 projects light through the first lens 220 and the light is directed to the user's eye. As illustrated in FIGS. 2A and 2B, the first housing 106 can define a first external surface 244. The second display assembly 104 can include a second lens 222, a second housing 108 surrounding the second lens 222 and defining a second internal volume 226 isolated from the first internal volume 224 by the first housing 106 and the second housing 108, and a second display screen 230 disposed in the second internal volume 226 that can project light through the second lens 222. As illustrated in FIGS. 2A and 2B, the second housing 108 can define a second external surface 246 separate and isolated from the first external surface 244. In this way, both the first display assembly 102 and the second display assembly 104 can operate individually of one another as separate display assemblies.

In at least one example, the HMD 100 can further include a bridge 232 extending between the first housing and the second housing to separate and couple the first housing 106 and the second housing 108. As illustrated in FIGS. 2A and 2B, the bridge 232 can separate the first housing 106 and the second housing 108 from each other. The bridge 232 can rest on the bridge of the user's nose while the user dons the HMD 100 to secure the HMD 100 to the user's face and align the first display screen 228 with a user's eye and the second display screen 230 with the user's other eye. In conventional HMDs the bridge of the user's nose can bear most of the weight of the HMD, and the fatigue can set in on the user's nose that can make donning the HMD for prolonged periods of time difficult and uncomfortable. In the present disclosure, the HMD 100 is lighter to increase the comfort of donning the HMD 100.

In at least one example, the HMD 100 can include a first securement arm 110 extending from the first housing 106 and a second securement arm 112 extending from the second housing 108. In at least one example, the first securement arm 110 and the second securement arm 112 can rest on the user's ear to distribute the weight of the HMD 100. The first securement arm 110 and the second securement arm 112 can remove the weight of the HMD 100 from the bridge of the user's nose to increase the comfort while donning the HMD 100. As illustrated in FIG. 2A, the first securement arm 110 and the second securement arm 112 can define a proximal end 234 coupled to the first housing 106 and the second housing 108, and a distal end 236.

In at least one example, the HMD 100 can further include a data transmission cable 238 electrically coupled to the first display screen 228 and extending through the first securement arm 110. The data transmission cable 238 can transfer data to the first display assembly 102 and the second display assembly 104. The HMD 100 further includes an electrical port 114 electrically coupled to the first display screen 228 and the second display screen 230 via the data transmission cable 238. The data transmission cable 238 can extend uninterrupted between the electrical port 114 and the first display screen 228 without being electrically coupled to any intervening processing components between the electrical port and the first display screen 228. As illustrated in FIG. 2A, the data transmission cable 238 can extend from the electrical port 114 of the second securement arm 112, through the second display assembly 104, extend through the bridge 232, extend through the first display assembly 102, and extend through the first securement arm 110.

In at least one example, the HMD 100 can further include a power cable 240 extending through the second securement arm 112 and electrically coupled to the second display screen 230 and the first display screen 228. In this example, the power cable 240 can transfer power from an external power source to the first display assembly 102 and the second display assembly 104. In this example, the HMD 100 can include a data transmission cable 238 extending through the first securement arm 110 and electrically coupled to the first display screen 228 and the second display screen 230, and a power cable 240 extending through the second securement arm 112 and electrically coupled to the first display screen 228 and the second display screen 230. The power cable 240 is electrically coupled to the electrical port 114. As illustrated in FIG. 2A, the electrical port 114 can be defined in the distal end 236 of the second securement arm 112. In at least one example, the first securement arm 110 can define a data port 242 positioned in the distal end 236 of the first securement arm 110, as illustrated in FIG. 2A. The data transmission cable 238 can be electrically coupled to the data port 242. It should be understood the electrical port 114 can be disposed in the first securement arm 110, or the second securement arm 112, or in a band, or the like, and the data port 242 can be disposed in the first securement arm 110, or the second securement arm 112, or a band, or the like.

In at least one example, the HMD 100 can include a singular port in either the first securement arm 110 or the second securement arm 112 that can transfer power and data to the first display assembly 102 and the second display assembly 104. For example, the power/data cable can extend through the first securement arm 110 to transfer power and data to the first display screen 228 and extend through the bridge 232 to transfer power and data to the second display screen 230. In this way, the external computing unit can electrically couple to a single port on the HMD 100. This can increase the ease of manufacturing and comfortability to the user while donning the HMD 100.

In these examples, the HMD 100 is free of computing components and an external computing unit can be electrically coupled to the HMD 100. The external computing unit can include a processor, a memory, a storage unit, a battery, and the like. The external computing unit can be electrically coupled to the HMD 100 via the electrical port 114 and the data port 242. In this example, the external computing unit can be a small component (e.g., a puck shape, square shape, or the like) that can fit into the user's pockets while donning the HMD 100. The external computing unit can include a wire extending and coupling with the electrical port 114 to provide power to the first securement arm 110 and a wire coupling to the data port 242 to provide data to the HMD 100. In one example, the HMD 100 can include a single power/data port and the wire extending from the external computing unit can electrically couple to the power/data port to transfer both data and power. In this way, the HMD 100 is free of the heavy computing units and cooling fans used for the computing units. Therefore, the HMD 100 can be lighter than conventional HMDs and can be donned by the user for extended periods of time.

Any of the features, components, and/or parts, of the electronic device including the arrangements and configurations thereof shown in FIGS. 2A and 2B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A and 2B.

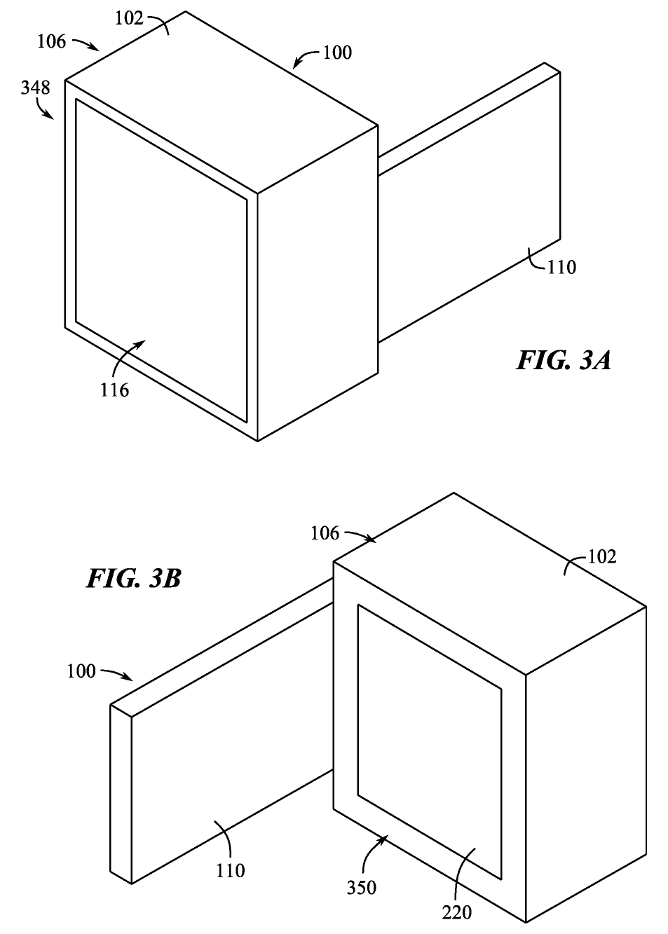

FIGS. 3A-3A through FIG. 3B illustrate various views of a portion of an HMD 100 of FIG. 1. FIG. 3A illustrates a front isometric view of the portion of the HMD 100. FIG. 3B illustrates a rear isometric view of the portion of the HMD 100. As illustrated in FIGS. 3A and 3B, the HMD 100 can include a first display assembly 102 that can include a first housing 106, a first lens 220, and a first cap 116 coupled to the first housing 106 opposite the first lens 220. The first display assembly 102 can further include a first display (not illustrated) disposed between the first lens 220 and the first cap 116. As illustrated in FIGS. 3A and 3B, the HMD 100 can further include a first securement arm 110 extending from the first housing 106.

As illustrated in FIG. 3A, the first cap 116 can cover a majority of the front surface 348 of the first display assembly 102. In at least one example, the first cap 116 can be opaque to block light from entering through the front surface 348 of the first display assembly 102. In this way, the first display assembly 102 and the first display screen can provide the most immersive experience to the user without light entering the device. In at least one example, the first housing 106 can surround the first cap 116, as illustrated in FIG. 3A. In at least one example, the first housing 106 110 can define a solid front surface 348 that does not include the first cap 116. In this way, light can still be blocked from entering in through the first housing 106. In this way, the first cap 116 and the first housing 106 can define a sleek and aesthetic look.

As illustrated in FIG. 3B, the first lens 220 can cover a majority of the rear surface 350 of the first display assembly 102. The first housing 106 can surround the first lens 220. The first lens 220 can be positioned in the first display assembly 102 such that the first lens 220 can align with the user's eye when the user dons the HMD 100. As illustrated in FIG. 3B, the first lens 220 can be a square lens. In at least one example, the first lens 220 can be a square lens, a circle lens, an octagonal lens, or the like.

As discussed above, the first securement arm 110 can include an eye cup (not illustrated) that can be coupled to the rear surface 350. In this example, the eye cup can be shaped accordingly to the shape of the first lens 220. When the user dons the HMD 100, the eye cup can secure to the user's eye socket to distribute the weight of the HMD 100 and to secure the HMD 100 to the user's face. For example, a user can don the HMD 100 while exercising and the eye cups can secure the HMD 100 to the user's face during the movement. Furthermore, the eye cups can block outside light from interfering between the light directed from the display screen through the first lens 220 to the user's eye. In this way, the HMD 100 with an eye cup can provide a more immersive experience.

Any of the features, components, and/or parts, of the electronic device including the arrangements and configurations thereof shown in FIGS. 3A and 3B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3A and 3B.

FIGS. 4A and 4B illustrate various views of the HMD 100 of FIG. 1. FIG. 4A. Illustrates an exploded view of the HMD 100. FIG. 4B illustrates a cross-section view of the HMD 100 through cut line A-A of FIG. 2B. In at least one example, the HMD 100 can include a first display assembly 102 that can include a first display screen 228, a first housing 106 surrounding the first display screen 228, a first lens 220 coupled to the first housing 106, and a first cap 116 coupled to the first housing 106 opposite the first lens 220. As illustrated in FIGS. 4A and 4B, the first housing 106 can be disposed between the first lens 220 and the first cap 116. Although not illustrated, it should be understood the HMD 100 can include a second display screen 230, a second housing 108 surrounding the second display screen, a second lens coupled to the second housing, and a second cap coupled to the second housing opposite the second lens. Therefore, the second housing can be disposed between the second lens and the second cap. In this way, the HMD 100 can define two distinct housings separate from one another.

As illustrated in FIGS. 4A and 4B, the first display screen 228 can be disposed between the first lens 220 and the first cap 116. In at least one example, the first display screen 228 can block light from passing between the first lens 220 and the first cap 116. The first display screen 228 is positioned to direct light provided by the first display screen 228 through the first lens 220 to the user's eye without the light leaking through to the front of the first display assembly 102 which can decrease the immersion and quality of displayed images. In this example, the second display screen can block light from passing between the second lens and the second cap.

In at least one example, the first lens 220 can be surrounded by the first housing 106. As illustrated in FIG. 4A, the first lens 220 can be disposed within the first housing 106 to create a flush interface. In another example, as illustrated in FIG. 4B, the first lens 220 can be positioned on the first housing 106. In this example, the first lens 220 covers the rear surface 350 of the first housing 106.

In at least one example, the first cap 116 can cover the front surface 348 to block light from entering in the first display assembly 102. In another example, the first cap 116 can be positioned within the first housing 106 to create a flush interface. In at least one example, the first cap 116 can be opaque to block light from entering into the HMD 100. In this way, the user cannot see through the HMD 100 as the HMD 100 is donned. The user will be immersed in only what is displayed via the display screens.

In at least one example, the HMD 100 can include an external computing unit. In conventional HMDs the computing units can be housed within the HMD and can significantly increase the weight of the HMD. In this way, the computing units create heat during operation and the conventional HMDs have to include cooling fans to cool the computing units during operation. In the present disclosure, the HMD 100 is free of computing components and the first display assembly 102 and the second display assembly do not include cooling fans. In at least one example, the HMD 100 can include a printed circuit board (PCB) 452 disposed within the first housing 106. The PCB 452 can include a plurality of resistors, capacitors, diodes, sensors, transistors, integrated circuits, and the like. The PCB 452 can be electrically coupled to the first display screen 228 to control the first display screen 228 during operation of the HMD 100.

In at least one example, the first housing 106 can include at least one vent 454. As illustrated in FIGS. 4A and 4B, the first housing 106 can include the vent 454 on the top and the bottom. In at least one example, a first housing 106 can include one vent 454, two vents 454, three vents 454, four vent s 454, or the like. The vent 454 can allow for cool air to enter the HMD 100 to cool down the limited computing components (e.g., the PCB 452, the first display screen 228, or the like). In this way, the HMD 100 can passively cool components without the use of energy consuming cooling fans that can add weight. Therefore, the HMD 100 in the present disclosure can significantly decrease the weight to increase the comfortability for extended use.

In at least one example, the HMD 100 can further include a bridge 232 that can connect a first display assembly 102 and a second display assembly. As discussed above, the bridge 232 can separate the first display assembly 102 and the second display assembly to create and are that can be positioned on the bridge of a user's nose when donning the HMD 100. In at least one example, the bridge 232 can electrically couple the first display assembly 102 and the second display assembly. In this example, the HMD 100 can include a power cable, a data cable, and/or a power/data cable that can electrically couple the first display assembly 102 and the second display assembly through the bridge 232.

Any of the features, components, and/or parts, of the electronic device including the arrangements and configurations thereof shown in FIGS. 4A and 4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A and 4B.

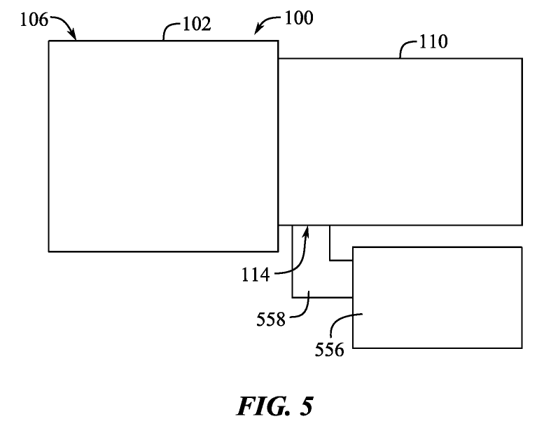

FIG. 5 illustrates a side view of an HMD 100. In at least one example, the HMD 100 can include a first display assembly 102 that can include a first housing 106, and a first securement arm 110 extending from the first housing 106. Although not illustrated, the HMD 100 can include a second display assembly that can include a second housing, and a second securement arm extending from the second housing. In one example, the HMD 100 can include a band or strap that can secure the first display assembly 102 and second display assembly to the user's face and position in front of the user's eyes. The securement arms can secure the HMD 100 to the user's face while the user participates in a variety of activities (e.g., office work, walking, exercising, or the like).

In at least one example, the HMD 100 can include an electrical port 114 that can be disposed in the first securement arm 110, the second securement arm, the band, the strap, the first housing 106, or the like. The HMD 100 can be free of computing components and can include an external computing unit 556. The external computing unit 556 can include a processor that can send all control signals to the HMD 100. In at least one example, the external computing unit 556 can include a battery that can send power to the HMD 100. In a least one example, the external computing unit 556 can further include, cooling fans, memory, storage, and the like.

The HMD 100 can further include an external computing unit power cable 558 that can electrically couple the electrical port 114 to the external computing unit 556. In at least one example, the external computing unit power cable 558 can extend from the electrical port 114 so the user can put the external computing unit 556 in a pocket while the donning the HMD 100. In at least one example, the external computing unit power cable 558 can vary based on the desired activity. For example, in an office setting a shorter wire may be desired to rest the external computing unit 556 on the desk as the user works. In another example, in an exercise setting a longer wire may be desired to position the external computing unit 556 in a pocket. In yet another example, the external computing unit 556 can be secured to the securement arms or the band or strap. In this example, a shorter external computing unit power cable 558 may be desired.

Although illustrated as one cable, the external computing unit power cable 558 can be two cables (e.g., a power cable and a data transmission cable). In this example, the power cable can electrically couple to the data port, such as the electrical port 114, and the data transmission cable can electrically couple to the data port, such as the data port 242 illustrated in FIG. 2A. In another example, the external computing unit power cable 558 can be a single wire extending from the external computing unit 556 that can split into a power cable and a data transmission cable.

Any of the features, components, and/or parts, of the electronic device including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user’s general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can allow users to select to "opt in" or "opt out" of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head-mountable display device, comprising:
a first display assembly including a first display and a first housing surrounding the first display;
a second display assembly including a second display and a second housing surrounding the second display;
a first securement arm extending from the first housing;
a second securement arm extending from the second housing;
a data transmission cable electrically coupled to the first display and extending through the first securement arm; and
an electrical port electrically coupled to the first display and the second display via the data transmission cable, the data transmission cable extending uninterrupted between the electrical port and the first display;
wherein the electrical port is configured to connect to an external computing unit configured to control visual outputs of the first display and the second display.

2. The head-mountable display device of claim 1, wherein the head mountable display device is free of computing components.

3. The head-mountable display device of claim 1, wherein the external computing unit comprises a processor and is configured to send control signals received by the first display and the second display via the data transmission cable.

4. The head-mountable display device of claim 1, wherein the first display assembly and the second display assembly are passively cooled.

5. The head-mountable display device of claim 1, wherein:
the first housing defines a first internal volume; and
the second housing defines a second internal volume isolated from the first internal volume by the first housing and the second housing.

6. The head-mountable display device of claim 1, further comprising a bridge extending between and connecting the first housing and the second housing.

7. The head-mountable display device of claim 6, wherein the data transmission cable extends through the bridge.

8. The head-mountable display device of claim 1, further comprising a power cable extending through the second securement arm and electrically coupled to the second display and the first display.

9. A wearable display device, comprising:
a first display module comprising:
a first lens;
a first housing surrounding the first lens and defining a first internal volume; and
a first display screen disposed in the first internal volume and configured to project light through the first lens;
a second display module comprising:
a second lens;
a second housing surrounding the second lens and defining a second internal volume isolated from the first internal volume by the first housing and the second housing;
a second display screen disposed in the second internal volume and configured to project light through the second lens;
a first temple arm extending from the first display module; and
a second temple arm extending from the second display module.

10. The wearable display device of claim 9, further comprising:
a first cap coupled to the first housing opposite the first display screen, the first housing disposed between the first lens and the first cap; and
a second cap separate from the first cap and coupled to the second housing opposite the second display screen, the second housing disposed between the second lens and the second cap.

11. The wearable display device of claim 9, further comprising a data transmission cable electrically coupled to the first display screen and extending through the first temple arm.

12. The wearable display device of claim 11, further comprising an electrical port electrically coupled to the first display screen and the second display screen via the data transmission cable, the data transmission cable extending between the electrical port and the first display screen without being electrically coupled to an intervening processing component between the electrical port and the first display screen.

13. The wearable display device of claim 12, wherein the first display module and the second display module are passively cooled.

14. The wearable display device of claim 9, wherein the first housing and the second housing comprising vent holes.

15. The wearable display device of claim 9, further comprising a bridge extending between the first housing and the second housing to separate and couple the first housing and the second housing.

16. A head-mountable device, comprising:
a first display assembly, comprising:
a first display;
a first housing surrounding the first display and defining a first external surface;
a first lens coupled to the first housing; and
a first cap coupled to the first housing opposite the first lens, the first display disposed between the first lens and the first cap;
a second display assembly, comprising:
a second display;
a second housing surrounding the second display and defining a second external surface separate and isolated from the first external surface;
a second lens coupled to the second housing; and
a second cap coupled to the second housing opposite the second lens, the second display disposed between the second lens and the second cap;
wherein:
the first display is configured to block light from passing between the first lens and the first cap; and
the second display is configured to block light from passing between the second lens and the second cap.

17. The head-mountable device of claim 16, wherein the first cap and the second cap are opaque.

18. The head-mountable device of claim 16, further comprising a bridge extending between and connecting the first housing and the second housing.

19. The head-mountable device of claim 18, further comprising a first securement arm extending from the first housing and a second securement arm extending from the second housing.

20. The head-mountable device of claim 19, further comprising:
a data transmission cable extending through the first securement arm and electrically coupled to the first display and the second display; and
a power cable extending through the second securement arm and electrically coupled to the first display and the second display.
